(19) United States
(12) Patent Application Publication
(10) Pub. No.: US 2017/0023178 A1
(43) Pub. Date: Jan. 26, 2017

(54) Apparatus and method to package hydrogen enriched liquids

(71) Applicant: Kurt Howard Ruppman, SR., Allen, TX (US)

(72) Inventor: Kurt Howard Ruppman, SR., Allen, TX (US)

(21) Appl. No.: 15/161,208

(22) Filed: May 21, 2016

Related U.S. Application Data
(60) Provisional application No. 62/164,692, filed on May 21, 2015.

(51) Int. Cl. F17C 3/00; F17C 13/06

(52) U.S. Cl. CPC F17C 3/00; F17C 13/06; F17C 2201/0104; F17C 2203/0646; F17C 2221/012; F17C 2260/036; F17C 2205/0311; F17C 2203/0619

(57) ABSTRACT

A hydrogen container for dispensing a hydrogen enriched liquid may include a base section having a cavity for the hydrogen enriched liquid; a truncated cone section connected to the base section; and a neck section connected to the truncated cone section. The neck section include a connecting device for sealing the hydrogen container including a seal having an interior layer formed of metal and an exterior layer.

### PRIORITY

The present invention claims priority based on 35 USC section 119 and provisional application with a Ser. No. 62/164692 which was filed on May 21, 2015.

### FIELD OF THE INVENTION

The present invention relates to containers and more particularly to a container to package hydrogen enriched liquids.

### BACKGROUND

Packaging liquids is well understood by the prior art. However, packaging hydrogen enriched liquids presents special problems arising from the relatively small size of the hydrogen molecule.

### SUMMARY

A hydrogen container for dispensing a hydrogen enriched liquid may include a base section having a cavity for the hydrogen enriched liquid; a truncated cone section connected to the base section; and a neck section connected to the truncated cone section. The neck section include a connecting device for sealing the hydrogen container including a seal having an interior layer formed of metal and an exterior layer.

The base section may be formed from aluminum.

The truncated cone section may be formed from aluminum.

The neck section may be formed from aluminum.

The base section may be formed from a material which prevents liquid hydrogen from escaping.

The truncated cone section may be formed from a material which prevents liquid hydrogen from escaping.

The neck section may be formed from material which prevents liquid hydrogen from escaping.

The neck section may be connected to a connecting device having female threads.

The connecting device may include a removable lid.

The removable lid may include male threads.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cutaway cross-sectional view of the hydrogen container of the present invention;

FIG. 2 illustrates a top view of the hydrogen container of the present invention;

FIG. 3 illustrates a cross-sectional view of the neck section of the hydrogen container of the present invention;

FIG. 4 illustrates a perspective view of the removable lid of the present invention;

FIG. 5 illustrates a cross-sectional view of the removable lid of the present invention;

FIG. 6 illustrates a bottom view of the hydrogen container of the present invention.

### DETAILED DESCRIPTION

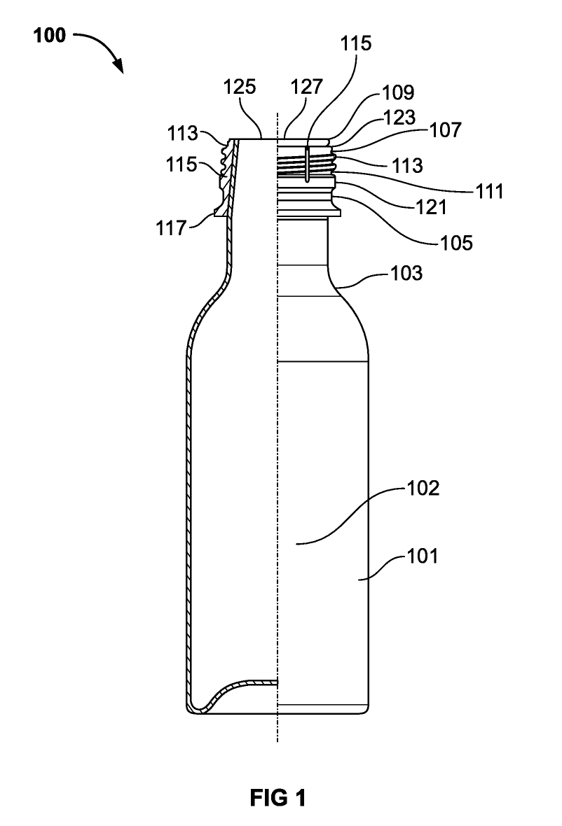

FIG. 1 illustrates a cross-sectional view of the hydrogen container 100 of the present invention, and the hydrogen container 100 may include a base section 101 which may include a cavity 102 to hold the hydrogen enriched liquid, a truncated cone section 103 which may be connected to the base section 101 and a neck section 105 which may be connected to the truncated cone section 103. The hydrogen container 100 may be formed from rigid metal, rigid aluminum or other appropriate material. The truncated cone section 103 may include a connecting device 107 (which may be formed from plastic or other suitable material) to connect to the neck section 105 and which may include a sealing cover 109 and a removable lid 111 which may be nondestructively removed and replaced on the connecting device 107.

The connection device 107 may include female threads 113 which may be a discontinuous and separated by an internal vertical channel 115 and a shoulder section 117 which may extend around the bottom periphery of the connection device 107. The shoulder section 117 may engage the bottom surface of a ring 119 of the removable lid 111. The ring 119 may be attached to the removable lid 111 by a weakened area 121 which may extend around the removable lid 111. The user may detach the ring 119 from the removable lid 111 by rotating the removable lid 111 causing a weakened area 121 to separate. The ring 119 may remain connected to the connecting device 107 after separation from the removable lid 111. The removable lid 111 may include male threads 123 on the interior surface of the removable lid 111 to engage (threadably connect) the female threads 113 which may be positioned on the exterior surface of the connecting device 107. The male threads 123 may be discontinuous and may include vertical channels to separate the thread sections. The connection device 107 may include a first central aperture 125 to allow hydrogen enriched liquid to enter and exit the hydrogen container 100. The hydrogen container 100 may include an axial second central aperture 127 to cooperate with the first central aperture 125 to allow the hydrogen enriched liquid to enter and exit the hydrogen container 100.

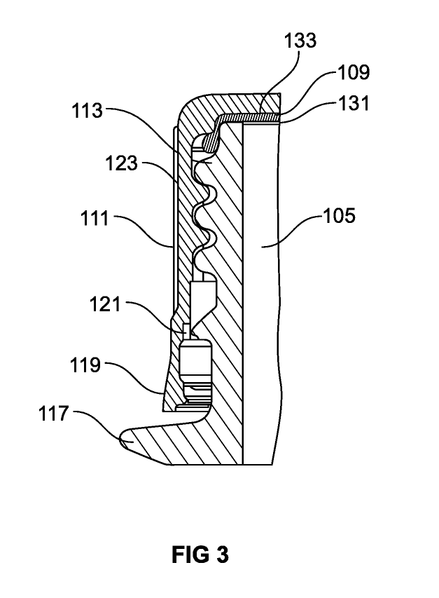

The seal cover 109 may cover the second central aperture 127 and may be connected to the upper surface of the neck section 105 by removable adhesive to allow access to the contents of the hydrogen container 100. The seal flexible cover 109 may include a first interior layer 131 and a second exterior layer 133 and the first interior layer 131 maybe formed from metal such as aluminum or other suitable metal material and the second exterior layer 133 may be formed from plastic or other suitable material FIG. 3 illustrates a cross-sectional view of a portion of the hydrogen container 100 of the present invention more particularly the neck section 105 which may be connected to the truncated cone section 103. The hydrogen container 100 may be formed from rigid metal, rigid aluminum or other appropriate material. The truncated cone section 103 may include a connecting device 107 to connect to the neck section 105 and which may include a sealing cover 109 and a removable lid 111 which may be nondestructively removed and replaced on the connecting device 107.

The connection device 107 may include female threads 113 which may be a discontinuous and separated by an internal vertical channel 115 and a shoulder section 117 which may extend around the bottom periphery of the connection device 107. The shoulder section 117 may engage the bottom surface of a ring 119 of the removable lid 111. The ring 119 may be attached to the removable lid 111 by a weakened area 121 which may extend around the removable lid 111. The user may detach the ring 119 from the removable lid 111 by rotating the removable lid 111 causing a weakened area 121 to separate. The ring 119 may remain connected to the connecting device 107 after separation from the removable lid 111. The removable lid 111 may include male threads 123 on the interior surface of the removable lid 111 to engage (threadably connect) the female threads 113 which may be positioned on the exterior surface of the connecting device 107. The male threads 123 may be discontinuous and may include vertical channels to separate the thread sections. The connection device 107 may include a first central aperture 125 to allow hydrogen enriched liquids to enter and exit the hydrogen container 100. The hydrogen container 100 may include an axial second central aperture 127 to cooperate with the first central aperture 125 to allow the hydrogen enriched liquids to enter and exit the hydrogen container 100.

The seal cover 109 may cover the second central aperture 127 and may be connected to the upper surface of the neck section 105 by removable adhesive to allow access to the contents of the hydrogen container 100. The seal flexible cover 109 may include a first interior layer 131 and a second exterior layer 133 and the first interior layer 131 maybe formed from metal such as aluminum or other suitable metal material and the second exterior layer 133 may be formed from plastic or other suitable material

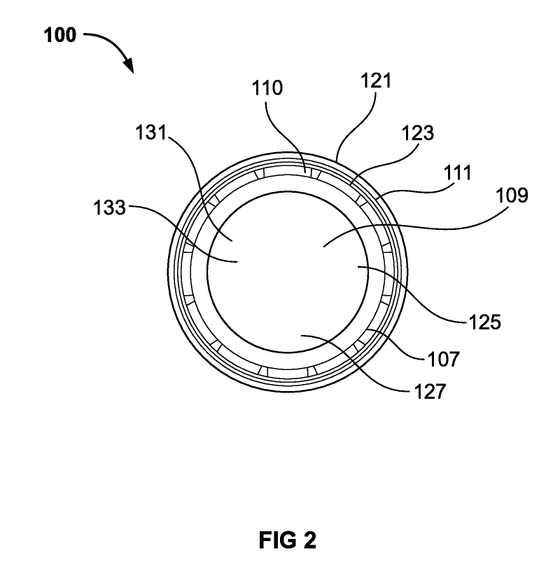

FIG. 2 illustrates a top view of the hydrogen container 100 and illustrates the connecting device 107, the seal flexible cover 109, the removable lid 111, the weakened area 121, the male threads 123, the central aperture 125, the second central aperture 127, the first interior layer 131, and the second exterior layer 133.

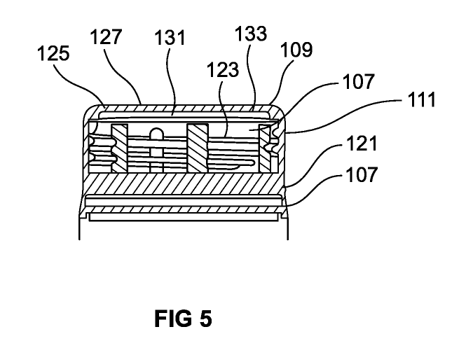

FIG. 5 illustrates a side view of the hydrogen container 100 and illustrates the connecting device 107, the seal flexible cover 109, the removable lid 111, the weakened area 121, the male threads 123, the central aperture 125, the second central aperture 127, the first interior layer 131, and the second exterior layer 133.

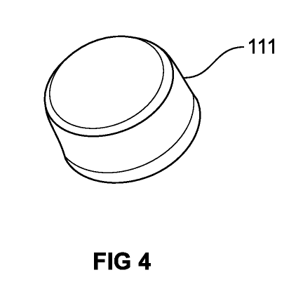

FIG. 4 illustrates a perspective view of the removable lid 111 of the present invention.

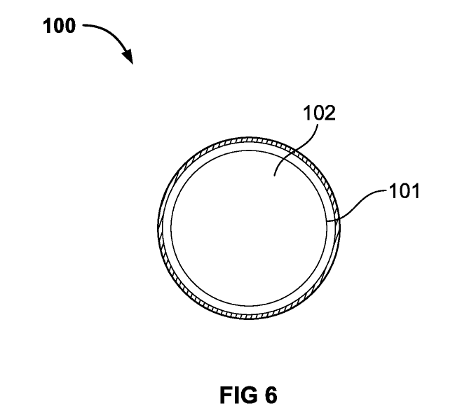

FIG. 6 illustrates a bottom view illustrating the base section 101 and the cavity 102.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A hydrogen container for dispensing hydrogen enriched liquid, comprising:
a base section having a cavity for the hydrogen enriched liquid;
a truncated cone section connected to the base section;
a neck section connected to the truncated cone section;
the neck section including a connecting device for sealing the hydrogen container including a seal having an interior layer formed of metal and an exterior layer.

2) A hydrogen container for dispensing hydrogen enriched liquid as in claim 1, wherein the base section is formed from aluminum.

3) A hydrogen container for dispensing hydrogen enriched liquid as in claim 1, wherein the truncated cone section is formed from aluminum.

4) A hydrogen container for dispensing hydrogen enriched liquid as in claim 1, wherein the neck section is formed from aluminum.

5) A hydrogen container for dispensing hydrogen enriched liquid as in claim 1, wherein the base section is formed from a material which prevents liquid hydrogen from escaping.

6) A hydrogen container for dispensing hydrogen enriched liquid as in claim 1, wherein the truncated cone section is formed from a material which prevents liquid hydrogen from escaping.

7) A hydrogen container for dispensing hydrogen enriched liquid as in claim 1, wherein the neck section is formed from material which prevents liquid hydrogen from escaping.

8) A hydrogen container for dispensing hydrogen enriched liquid as in claim 1, wherein the neck section is connected to a connecting device having female threads.

9) A hydrogen container for dispensing hydrogen enriched liquid as in claim 8, wherein the connecting device includes a removable lid.

10) A hydrogen container for dispensing hydrogen enriched liquid as in claim 9, wherein the removable lid includes male threads.
